(19) United States
(12) Patent Application Publication
(10) Pub. No.: US 2006/0010301 A1
(43) Pub. Date: Jan. 12, 2006

(54) Method and apparatus for file guard and file shredding

(75) Inventor: Yuichi Yagawa, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/885,928

(22) Filed: Jul. 6, 2004

(51) Int. Cl. G06F 12/14

(52) U.S. Cl. 711/163; 711/114

(57) ABSTRACT

Techniques to assure genuineness of data stored on a data retention system are provided. The data retention system includes a file server system and a storage system. The file server system is configure to map a data file to contiguous memory blocks of the storage system in one embodiment. The storage system is configured to store a write protect attribute associated with the contiguous memory blocks. The storage system denies write access to the contiguous memory blocks depending on the write protect attribute.

### BACKGROUND OF THE INVENTION

The invention relates to generally to the field of storage devices, and more particularly to techniques to assure the genuineness of data stored on storage devices.

An important aspect of today's business environment is compliance with new and evolving regulations for retention of information, specifically, the processes by which records are created, stored, accessed, managed, and retained over periods of time. Whether they are emails, patient records, or financial transactions, businesses are instituting policies, procedures, and systems to protect and prevent unauthorized access or destruction of these volumes of information. The need to archive critical business and operational content for prescribed retention periods, which can range from several years to forever, is defined under a number of compliance regulations set forth by governments or industries. These regulations have forced companies to quickly re-evaluate and transform their methods for data retention and storage management.

For example, in recent times, United States governmental regulations have increasingly mandated the preservation of records. United States government regulations on data protection now apply to health care, financial services, corporate accountability, life sciences, and the federal government. In the financial services industry, Rule 17a-4 of Securities Exchange Act of 1934, as amended, requires members of a national securities exchange, brokers, and dealer to retain certain records, such as account ledgers, itemized daily records of purchases and sales of securities, brokerage order instructions, customer notices, and other documents. Under this rule, members, brokers, and dealers are permitted to store such records in an electronic storage media if the preserved records are exclusively in a non-rewriteable, non-erasable format.

In addition, organizations and businesses can have their own document retention policies. These policies sometimes require retention of documents for long periods of time. The National Association of Securities Dealers (“NASD”), a self-regulatory organization relating to financial services, has such rules. For example, NASD Rule 3110 requires each of its members to preserve certain books, accounts, records, memoranda, and correspondence.

Preserved records can take many forms, including letters, patient records, memoranda, ledgers, spreadsheets, email messages, voice mails, and instant messages. Accordingly, the volume of preserved records can be vast, requiring high transaction speeds and large capacities to process. In addition, preserved records may exist in many disparate electronic formats, such as PDF files, HTML documents, word processing documents, text files, rich text files, Microsoft EXCEL™ spreadsheets, MPEG files, AVI files, or MP3 files.

A number of conventional methods currently use upper level software or application software to preserve data in a non-rewriteable, non-erasable format. For example, upper level software, such as electronic mail archiving software, can be tailored to prevent deletion of data. However, upper level software programs implementing write protection are generally perceived to be unreliable, vulnerable to security flaws, and easily bypassed at the storage medium level. Moreover, upper level software implementations can prove to be costly since such implementations will need to process many disparate forms of data originating from many sources.

Another conventional method for data preservation would be to use the file system's default functions, such as “chmod” in the Unix operating system. The chmod function allows users to set write protection to particular files. However, such protection can be easily bypassed. For example, another user can modify the storage area of the file by using a low level I/O function like “write” system call.

A hard disk based storage system, such as a redundant arrays of inexpensive disks (RAID) system, can provide write once read many (WORM) capability. The controllers of these storage systems contain micro programs which can implement a WORM function. For example, Hitachi Freedom Storage™ LDEV Guard provides this functionality. This method does provide an increased level of trustworthiness as ordinary users do not have access to the micro program. However, these implementations require add-on technologies since write protection is physical or logical volume based, not file based.

To safeguard information, governmental regulations may also mandate data shredding when preserved data is no longer to be retained. For example, DoD 5220.22-M National Industrial Security Program Operating Manual (NISPOM) provides procedures to clear and sanitize electronic media. A detailed description of required procedures under NISPOM, including its Clearing and Sanitization Matrix, can be found at http://www.dss.mil/isec/nispom.pdf, which is incorporated herein by reference for all purposes. These procedures include overwriting all addressable locations with a single character or overwriting all addressable locations with a character, its complement, and then a random character.

File systems' default functions for file deletion, such as the “rm” command for Unix operating systems, do not implement data shredding procedures. Moreover, these default functions would fail to instill a high level of trust with auditors since they are based on generally available software. Even RAID systems, which can offer shredding capability, require add-on technologies to achieve file shredding, since shredding is based on physical or logical volume, and is not file based.

As can be appreciated, conventional techniques for retaining and shredding data lack precautions necessary to instill confidence in the stored data by auditors, regulatory compliance officers, or inspectors. There is a need for improvements in storage devices, especially for techniques to archive and shred data and increase the trustworthiness of such data.

### BRIEF SUMMARY OF THE INVENTION

Embodiments of the present invention provide techniques to assure genuineness of data stored on a data retention system. The data retention system includes a file server system and a storage system. The file server system is configure to map a data file to contiguous memory blocks of the storage system in one embodiment. The storage system is configured to store a write protect attribute associated with the contiguous memory blocks. The storage system denies write access to the contiguous memory blocks depending on the write protect attribute.

According to an embodiment of the present invention, a storage system includes a storage area defined by a plurality of disks. This storage area defines at least one logical volume, the logical volume including a first portion of contiguous blocks and a second portion of contiguous blocks. First and second files are stored in the first and second portions, respectively. The storage system is configured to lock the first portion without locking the second portion, so that first data of the first file stored in the first portion is protected according to an attribute associated with the first portion while the second data of the second file is not protected. A communication interface couples the storage system to a file server system. Access to the storage area is controlled by a storage controller.

According to another embodiment of the present invention, a file server system is provided. The file server system includes control logic configured to receive a command to write protect a first data file. Control logic of the file server system also determines a current moment in time. A first data file is mapped to contiguous memory blocks in a logical volume by control logic. The interface between the file server system and a storage system is controlled by control logic. The storage system includes a plurality of hard disk drive units defining at least one logical volume.

According to yet another embodiment of the present invention, a method of assuring genuineness of retained data on a storage system with a plurality of disk drives is provided. The size of at least one data file is determined. Next, the at least one data file is stored in contiguous memory blocks. A write protect attribute and address information associated with the contiguous memory blocks are also stored. Write access to the contiguous memory blocks is dependent on the write protect attribute and the address information.

According to another embodiment, a metatable stored by a storage system to manage at least one extent of the storage system is provided. The metatable includes an identifier for the at least one extent, extent address information, a write protection flag for the at least one extent, and retention period information for the at least one extent. The at least one extent includes one, two, three, or more data files.

### BRIEF DESCRIPTION OF THE DRAWINGS

FIG. 1 illustrates a simplified system diagram of an exemplary data retention system incorporating an embodiment of the present invention.

FIG. 2 is a simplified system diagram of an exemplary storage system incorporating an embodiment of the present invention.

FIG. 3 is a simplified flowchart that illustrates aspects of an exemplary procedure using the invention at the application software level.

FIG. 4 is a simplified flowchart that illustrates aspects of an exemplary procedure using the invention at the file server system level.

FIG. 5 is a simplified flowchart that illustrates aspects of an exemplary procedure using the invention at the storage system level.

FIG. 6 is a simplified flowchart showing an exemplary procedure for processing a write request at the storage system level.

FIG. 7 is a simplified flowchart of an exemplary procedure at the storage system level for maintaining retained data.

FIG. 8 shows an example of a memory map using a conventional file address management system.

FIG. 9 shows an example of a memory map using a file address management system according to an embodiment of the present invention.

FIG. 10 shows an example of an image bitmap of disk space using a conventional free space management system.

FIG. 11 shows an example of an image bitmap of disk space using a free space management system according to an embodiment of the present invention.

FIG. 12 shows an exemplary format of a metatable according to one exemplary embodiment of the present invention.

### DETAILED DESCRIPTION OF THE INVENTION

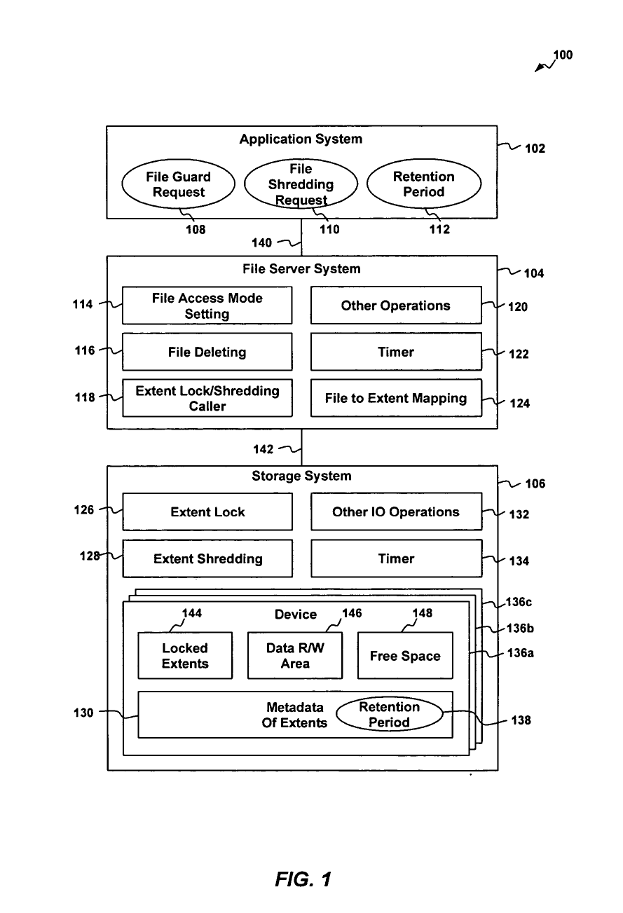

FIG. 1 illustrates a simplified system diagram of an exemplary data retention system 100 incorporating an embodiment of the present invention. Data retention system 100 includes application system 102, files server system 104, and storage system 106. In alternative embodiments, data retention system 100 can include several of each of such systems for load balancing or increased redundancy. For example, data retention system 100 may include two, three, four, or more storage systems 106. Furthermore, application system 102, file server system 104, and storage system 106 may be combined in any combination. For instance, file server system 104 and storage system 106 can be combined as one integrated system which provides both file management and storage devices.

Application system 102 receives requests directly from a user or another application program to write protect or shred (respectively referred to herein as file guard and file shred) specific data files. Application system 102 can be any program or device capable of performing data write or delete functions directly for the user or another application program. In one embodiment, application system 102 is an operating system (such as a Unix operating system, Linux operating system, Windows™ operating system by Microsoft Corporation, or Macintosh operating system by Apple Computer Inc.). In other embodiments, application system 102 can be any application program including without limitation a database program, word processor, Internet browser, document management program (such as iManage WorkDocs™ by iManage, Inc.), email program, or multimedia file management program.

Application system 102 is a client of file server system 104 and sends requests related to file access to file server system 104, such as file guard request 108 and file shredding request 110. File guard request 108 commands file server system 104 to guard specified files at the hardware level. In other words, the specified files are write once read many (WORM) locked and cannot be modified or deleted by either application system 102 or file server system 104 during a specified retention period 112. File guard request 108 differs from the file access mode setting function 114, such as the “chmod” command of UNIX operating systems, as it ensures hardware level write protection. Likewise, file shredding request 110 commands file server system 104 to shred specified files at the hardware level. In other words, these files are overwritten logically and physically with a random bit pattern to become irrecoverable at the hardware level. This function to decommission files at the hardware level can be automatically implemented at the end of retention period 112 or requested specifically by a user at the end of retention period 112. It should be noted that, in an embodiment of the present invention, file guard request 108 and file shredding request 110 can be implemented using the existing syntax of the operating system, such as the “chmod” command or “rm” command, or menu commands in an application program, thereby preserving the user interface.

File server system 104 maps data files retained by file guard to an extent, or a contiguous physical or logical space in storage system 106. In an embodiment of the present invention, extents may have three states: free extent, data extent, or locked extent. A free extent is free, continuous storage space. A data extent is an extent being used to store data. A locked extent is an extent locked to prevent modifications to its stored data. For a specific application, extents may have additional states. Based on the disclosure and teachings provided herein, a person of ordinary skill in the art will know how to select the appropriate states for a specific application.

File server system 104 also provides storage system 106 with extent metadata (such as memory address, block size, write protect status, and retention period) as well as metadata relating to the specific data files (such as file memory address, file block size, and file type). Storage system 106 uses this metadata to appropriately process write or delete I/O requests related to the extent or data file.

Application system 102 is connected to file server system 104 through a network connection 140. Network connection 140 may be any suitable communication network including a wide area network (WAN), local area network (LAN), the Internet, a wireless network, an intranet, a private network, a public network, a switched network, combinations thereof, and the like. Network connection 140 may include hardwire links, optical links, satellite or other wireless communications links, wave propagation links, or any other mechanisms for communication of information. Various communication protocols (such as TCP/IP, HTTP protocols, extensible markup language (XML), wireless application protocol (WAP), vendor-specific protocols, customized protocols, and others) may be used to facilitate communication between application system 102 and file server system 104.

File server system 104 is connected to storage system 106 through a network connection 142. Examples of network connection 142 include connections based a storage area network (SAN), FibreChannel protocol (FCP), or small computer system interface (SCSI). If file server system 104 and storage system 106 are combined as network attached storage (NAS), then network connection 142 can be based on Infiniband (an architecture and specification for data flow between processors and I/O devices), peripheral component interconnect (PCI), or other proprietary protocols.

File server system 104 provides several file access functionalities to its clients, including conventional functions such as file access mode setting 114, file deleting 116, and other file access operations 120. File access mode setting 114 restricts file modification or deletion at the file system level. However, write protection at the file system level may not adequately safeguard data as required by regulatory rules and guidelines which sometimes specify hardware level protection. Similarly, using timer 122 and file deleting 116 to determine the retention period and to delete the file at the file system level may not comply with regulatory rules and guideline which can require the decommissioning of data at the hardware level.

Therefore, according to an embodiment of the present invention, file server system 104 provides extent lock/shredding caller 118 and file-to-extent mapping function 124. File-to-extent mapping function 124 maps particular files to an extent. Under conventional file management systems, a file is generally stored in dispersed blocks, and seldom are several files stored in continuous blocks. However, in order to efficiently use extent level lock or shredding functions on the storage system 106, file server system 104 maps the specified files to an extent.

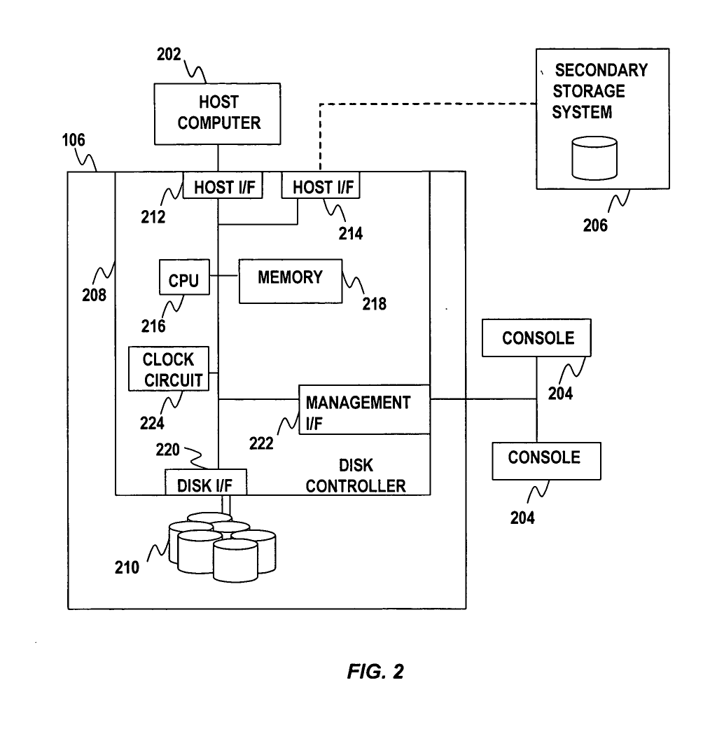

FIG. 2 illustrates a simplified system diagram of an exemplary storage system 106 incorporating an embodiment of the present invention. It should be recognized that other combinations of hardware and software, or architectures, can implement storage system 106. In this embodiment, storage system 106 (or disk array unit, disk storage unit, or storage subsystem) includes a disk controller 208 (or storage controller) and a plurality of disks 210. Disk controller 208 controls the operations of disks 210 to enable the communication of data to and from disks 210 to a host computer 202. For example, disk controller 208 formats data to be written to disks 210 and verifies data read from disks 210.

Disks 210 are one or more hard disk drives in the present embodiment. In other embodiments, disks 210 may be any suitable storage medium including floppy disks, CD-ROMs, CD-R/Ws, DVDs, magneto-optical disks, combinations thereof, and the like. Each of disks 210 is installed in a shelf in storage system 106. Storage system 106 tracks the installed shelf location of each disk using identification information. The identification information can be a numerical identifier starting from zero, which is called an HDD ID. Furthermore, each disk has a unique serial number which can be tracked by storage system 106.

Disk controller 208 includes host interfaces 212 and 214 (or channel interfaces), disk interface 220, and management interface 222 to interface with host computer 202, secondary storage system 206, disks 210, and consoles 204. Host interface 212 provides a link between host computer 202 and disk controller 208. It receives the read instructions, write instructions, and other I/O requests issued by host computer 202. Host interface 214 can be used to connect secondary storage system 206 to disk controller 208 for data migration. Alternatively, host interface 214 can be used to connect an additional host computer 202 to storage system 106. Disks 210 are connected to disk controller 208 through disk interface 220. Management interface 222 provides the interface to consoles 204. In addition, disk controller 208 includes a central processing unit (CPU) 216, a memory 218, and a clock circuit 224. CPU 216 extracts instructions from memory 218 and executes them to run storage system 106. Clock circuit 224 is used to provide the timer 122 function.

According to an embodiment of the present invention, storage system 106 provides the following functions: extent lock function 126, extent shredding function 128, timer 134, and other I/O operations 132. Extent lock 126 restricts WRITE I/O operations, including data deletion, to a specific extent at the hardware level, which means that this function rejects any write or delete command from the file server system 104 to the extent. Extent shredding 128 overwrites the specified extent to decommission the data at the hardware level. Timer 134 is used determine the expiration of the retention period. In order to protect the integrity of timer 134, it may not be directly accessible by application system 102 or, in some embodiments, even file server system 104.

In the present embodiment, storage system 106 contains one or more physical or logical devices 136a-c. Physical or logical devices 136a-c can be implemented by one or more hard disk drives. Storage system 106 may include 1, 10, 100, 1,000, or more hard disk drives. In implementations of the present invention for a single personal computer, a storage system will generally include fewer than 10 hard disk drives. However, for large entities, such as a leading financial management company, the number of hard disk drives can exceed 1,000.

Each of the one or more physical or logical devices 136a-c can include locked extents 144, data R&W area 146, free space 148, and metadata of extent 130. Locked extents 144 are the collective locked extents. Data R&W area 146 is the collective data extents. Free space 148 is the collective free extents. Data describing the locked extent 144, such as address, flags for lock and shredding, retention period 138, and others, is stored as metadata of extent 130. The metadata of extent 130 is not directly accessible by systems external to storage system 106.

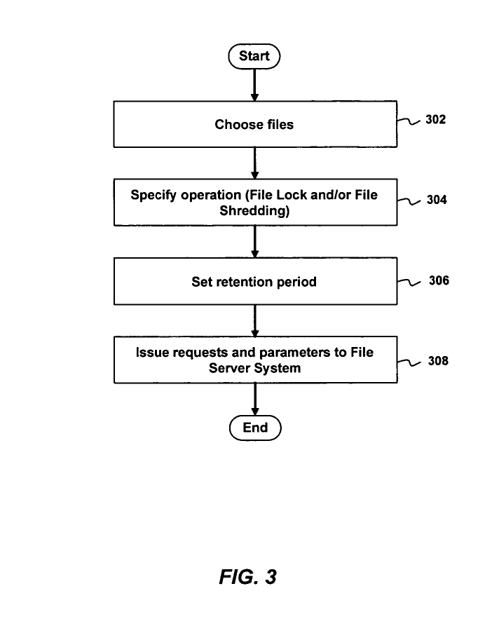

FIG. 3 is a simplified flowchart that illustrates aspects of an exemplary procedure using the invention at the application software level. Using a user interface provided by application system 102, such as graphic user interface (GUI) or command line interface (CLI), the user in step 302 specifies data files to file guard or file shred. Next, in step 304, the user indicates the operation(s) to apply, file guard request 108 or file shred request 110, to the selected files. The user can request: (i) file guard with file shredding at the end of the retention period, (ii) file guard without file shredding at the end of the retention period, or (iii) file shredding. For example, the user can specify files and operation using the “chmod” command in Unix operating system. The user, in step 306, can set retention period 112 for write protecting the selected files. Retention period 112 can be any period of time, but may be specified by governmental regulation for a particular application. For example, retention period 112 may be one day, one week, one month, one year, five years, or more. Alternatively, step 306 can be skipped altogether and the files automatically saved into perpetuity or any lesser predetermined period (e.g., 99 years, 7 years, 90 days, or others). In step 308, application system 102 provides file server system 104 with these parameters (e.g., selected files, operations, and retention period).

In another embodiment, data retention system 100 can automatically select the files, appropriate operations, and the retention period based on a document retention policy. This document retention policy, created by a user, system administrator, or regulatory compliance officer, can be based on the data file type, file owner, file name, file creation or modification dates, and the like.

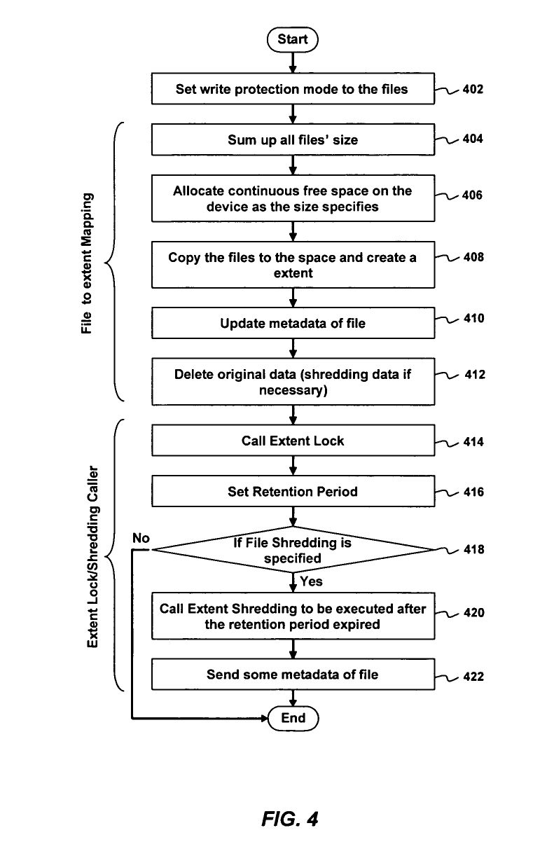

FIG. 4 is a simplified flowchart that illustrates aspects of an exemplary procedure using the invention at the file server system level. When file server system 104 receives the file guard request 108 and/or file shredding request 110 from application system 102, it sets write protection to the selected files as shown in step 402 using file access mode setting 114, such as the “chmod” command in Unix operation systems. Step 402 restricts access to the files by the user or the application system 102 while the file server system 104 is executing the file guard request 108 and/or file shredding request 110. Step 402 can be executed at anytime before execution of the file-to-extent mapping function 124 and the extent lock/shredding caller function 118.

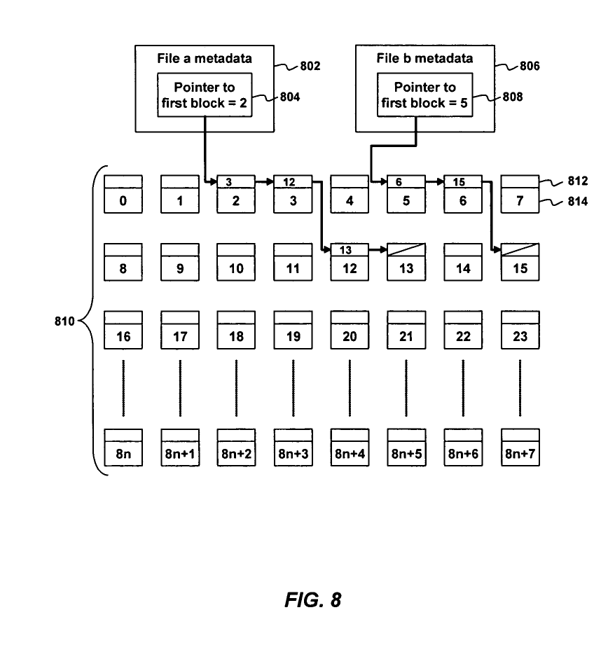

File-to-extent mapping function 124 is accomplished by steps 404 to 412. In step 404, file server system 104 calculates the aggregate file size in number of block for the data files specified by application system 102. FIG. 8 is an example illustrating an implementation of the file size calculation. FIG. 8 show a data r/w area 146 using conventional file address management. In this example, “File a” and “File b” have been specified by file guard request 108. Metadata 802 and 806 contain information about File a and File b, respectively, such as user and group ownership, access mode (read, write, execute permissions) and type. In data retention systems using a Unix file system, metadata 802 and 806 can be implemented using the i-node data structure existing in Unix systems. Also, metadata 802 and 806 each includes a pointer 804 and 808, respectively, to the address of the first block corresponding to the applicable file in memory device blocks 810. Each block has an address 814 and a pointer to the next block 812. For example, metadata 802 includes a pointer 804 to block address 2 as the first block of File a. Block 2 includes a pointer to block address 3 (the second block of File a). Following the chain of pointers, file server system 104 can determine that File a consists of blocks 2, 3, 12, and 13. Similarly, File b can be determined to consist of blocks 5, 6, and 15. In step 404 of FIG. 4, file server system 104 sums the aggregate block size of File a and b, which is 7 blocks.

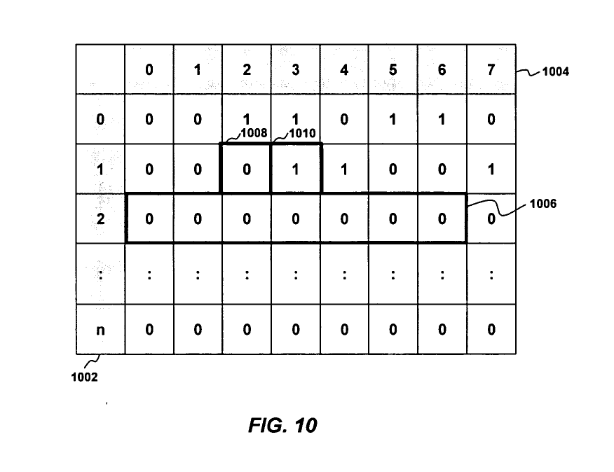

Next, in step 406, file server system 104 allocates sufficient continuous free space (a free extent) from free space 148 on the device 136 to store the files specified by file guard request 108. Step 406 is explained with reference to FIG. 10, which illustrates one method to manage free space by file server system 104. An image bitmap of the disk space (referred herein as the free space bitmap) indicates for each block (physical or logical) whether it is data space or free space. The row numbers 1002 and column numbers 1004 can together uniquely identify the address for each block. For example, the address of the block 1008 can be calculated as the sum of the column number and the product of the row number and eight, or address 10 (2+1*8). In this embodiment, the value stored in each box indicates if the block is free (0) or occupied (1). For example, the block 1008 is free space, while block 1010 is occupied data space. In step 406, file server system 104 finds continuous free space in the bitmap and defines it as a free extent. For example, blocks 1006, addresses 16 to 22, define a free extent of size 7. If file server system 104 cannot allocate a sufficiently large free extent for a particular file guard request 108 due to high fragmentation in memory, it may need to run known defragmentation routines to increase free extent sizes. If there is still insufficient space in the memory devices after running the routine, the file server system 104 sends an alert or error message to application system 102.

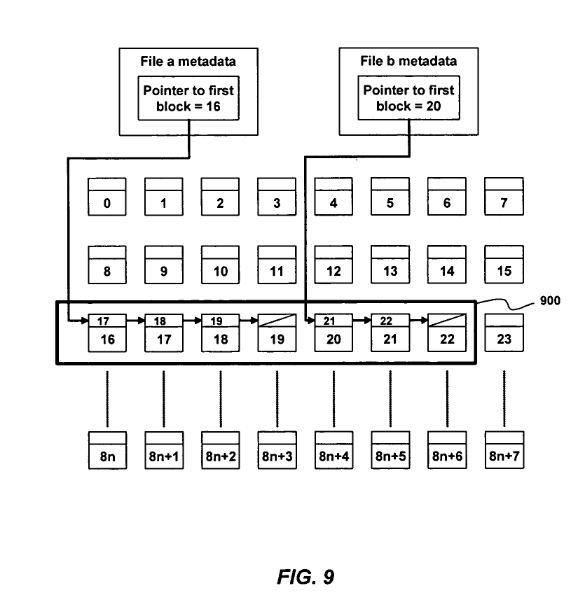

File server system 104, in step 408, copies or moves the selected data files to a free extent to create a data extent. This function differs from a conventional file copy or move function in that the address of a free extent is specified. Next, in step 410, file server system 104 updates the selected files' metadata to record the address of the created data extent. For the example introduced in FIG. 8, the resulting memory map after step 410 is shown in FIG. 9. The address pointer to the first block for File a and File b are updated to block address 16 and block address 20, respectively. Due to step 410, File a is saved in contiguous blocks 16, 17, 18, and 19. File b is saved in contiguous blocks 20, 21, and 22. Moreover, File and File b, together, occupy contiguous blocks, or extent 900, in memory.

In step 412, file server system 104 deletes the original data on the device. In other words, file server system 104 removes the address links to the original blocks and updates the free space bitmap to reflect that these blocks are free blocks. In addition, if requested by the user or application system 102, file server system 104 can call a hardware shredding function, or block shredding (which differs from extent shredding), to ensure that the original block data is non-recoverable.

File server system 104, in step 414, calls an extent lock function 126 of storage system 106. As parameters for the extent lock function 126, file server system 104 sends the starting block address and extent size to storage system 106. In addition, if applicable, file server system 104 in step 416 may provide retention period 112 to the storage system 106. If file server system 104 and storage system 106 represent the retention period 112 in differing units of time, retention period 112 may be transformed to the unit of time expected by storage system 106. For example, the retention period 112 may be expressed in units of seconds by storage system 106 and days or calendar date by file server system 104.

If file server system 104, in step 418, determines that the user or application system 102 has requested file shredding, file server system 104 in step 420 calls the extent shredding function 128 of storage system 106. Storage system 106 will then decommission the extent at the end of the specified retention period. File server system 104 also provides storage system 106 with starting block address and extent size in order to execute extent shredding. In another embodiment, file server system 104 may manage and/or monitor the retention period. At the end of the retention period, file server system 104 can call an extent shredding function after the retention period has expired.

In step 422, file server system 104 provides file metadata to storage system 106. File metadata is saved along with extent metadata. For example, file name and file owner can be sent as file metadata. File metadata may be used to support an audit, especially if the retained files are not readily available. Moreover, file metadata should be sufficiently detailed to allow an auditor or regulatory compliance officer the ability to retrieve a locked file directly from memory. The ability to retrieve files from memory may be need if file server system 104 becomes corrupted during the retention period. Otherwise, the retained files could be irrecoverable.

In another embodiment, file server system 104 can initially save file data to continuous free space (i.e., an extent). Thereby, steps relating to the copy and deletion of original data are avoided or appropriately modified. For example, in step 408, file server system 104 writes file data to an extent instead of copying the data. Also, step 412 is avoided as duplicated data does not exist. In addition, file server system 104 locks this extent, sets its retention period, and shreds the file at the expiration of the retention period as specified in steps 414 through 422. This embodiment can be especially useful when applied to content addressable storage (CAS). These systems focus on managing reference information or fixed contents which are never expected to be modified.

In yet another embodiment, file data can be stored in multiple extents. File system 104 then guards each of these extents. Saving file data to multiple extents may be necessary if file system 104 is unable to allocate sufficient continuous free space for file data. Therefore, instead of copying (or writing) file data to a single extent, the file system directly guards or shred each of the constituent extents used to store file data. For example, in FIG. 8, blocks 2, 3, 12, and 13 can be locked if file 802 is guarded.

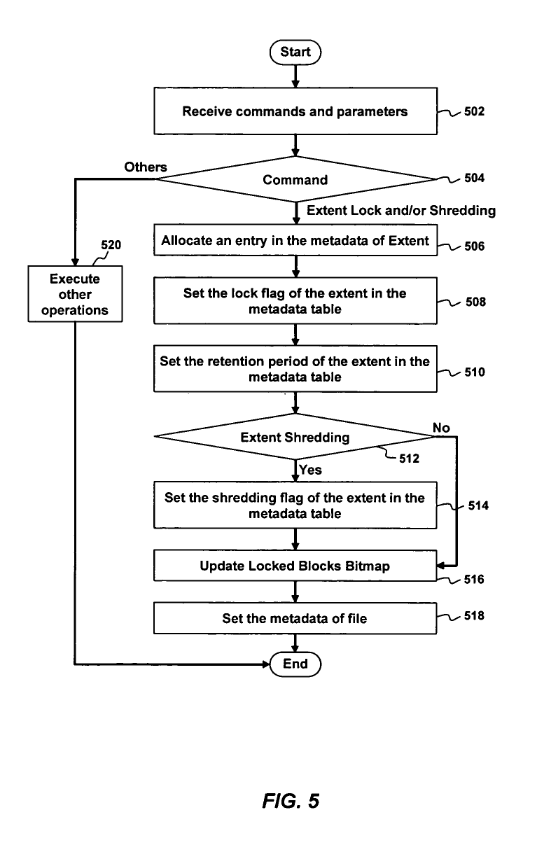

FIG. 5 is a simplified flowchart that illustrates aspects of an exemplary procedure using the invention at the storage system level. As shown in step 502, storage system 106 receives from file server system 104 command(s) and parameters. Related to data retention, storage system 106 can receive commands: (i) extent lock 126, (ii) extent lock 126 and extent shredding 128, or (iii) extent shredding 128. The parameters for these commands may include extent address, extent size, retention period 138, and other file metadata. Storage system 106, in step 504, identifies the called command(s) and dispatches the appropriate processes. If storage system 106 determines that the requested command is extent lock 126 and/or extent shredding 128, then steps 506 to 518 are executed. Otherwise, storage system 106 executes processes unrelated to data retention in step 520.

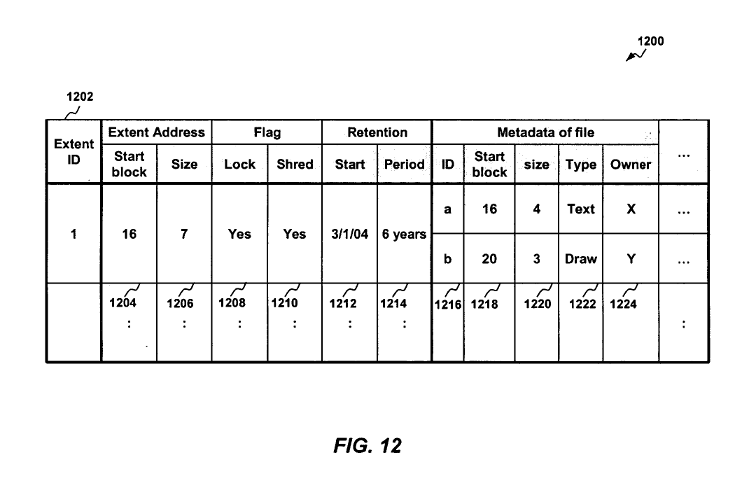

In step 506, storage system 106 allocates an entry for the extent in the metadata of extents 130. The entry can include an extent identifier, extent address starting block, and extent size, as well as other information. An embodiment of a metatable implementing metadata of extents 130 is discussed below in connection with FIG. 12. As shown in steps 508, 510, 512, and 514, storage system 106 saves the appropriate flags and metadata for the extent.

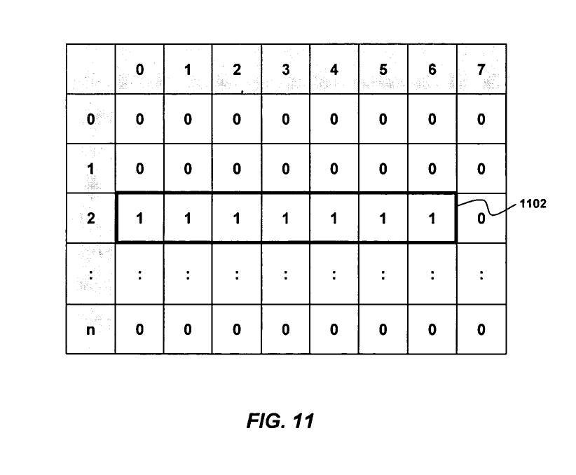

Storage system 106, in step 516, updates a locked blocks bitmap. The locked blocks bitmap identifies the status of memory blocks, locked or unlocked. FIG. 11 is an example of a locked blocks bitmap. From our example discussed in connection with FIG. 9, blocks 1102 in FIG. 11 are updated to represent the locked extent comprising File a and File b. In step 518, storage system 106 saves file metadata to metadata of extents 130. As illustrated in FIG. 12, two sets of file metadata are added since the extent, in our example, includes two files, File a and File b. File metadata is discussed in detailed below in connection with FIG. 12.

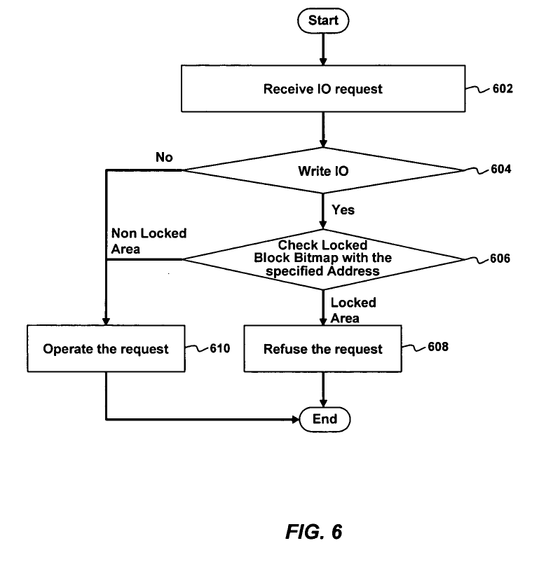

FIG. 6 is a simplified flowchart showing an exemplary procedure for processing a write request at the storage system level. In step 602, storage system 106 receives an input output (I/O) request from file server system 104 or another external system. Storage system 106, in step 604, determines if the I/O request is a write or delete request. If not, storage system 106 proceeds to step 610 and performs the requested operation. If the I/O request is a write or delete request, storage system 106 in step 606 compares the address specified in I/O request against the locked blocks bitmap. An example of the address specified in the I/O request is logical block address entry in the command descriptor block (CDB) of a SCSI command. If the locked blocks bitmap identifies the specified address as locked (e.g., address is within a locked extent), the request is refused as shown in step 608. Otherwise, if the address is unlocked, the request is processed in step 610.

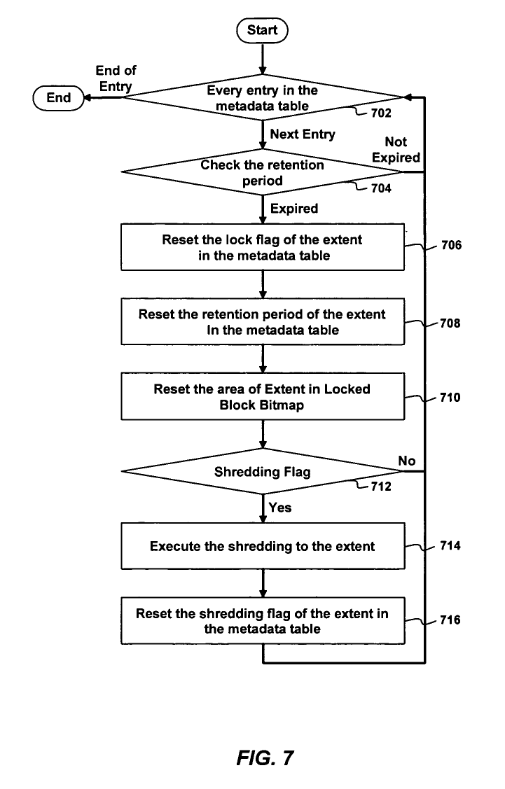

FIG. 7 is a simplified flowchart of an exemplary procedure at the storage system level for maintaining retained data. Storage system 106 periodically checks retention periods and performs extent shredding when needed. These periodic checks can be performed on any schedule (such as, once a minute, hour, day, month, or year). The periodic checks preferably should be based on the time unit of the retention period. For example, if the smallest unit of time for any retention period is a day, then the retention period check should be performed at least once a day (e.g., 12:00 a.m. each day). In this example, if the retention period check is not performed at least once a day, then extents will be locked for a period longer than the required retention period and locked blocks will not be freed until the next check.

As shown by step 702, storage system 106 executes steps 704, 706, 708, 710, 712, 714, and 716 for every entry in the metadata table, or metatable. In step 704, storage system 106 checks the retention period of an entry. If the retention period has expired, storage system 106 proceeds to step 706; otherwise, it begins the process for the next entry. In one embodiment, storage system 106 includes a timer 134 (or clock) to check retention periods. The elapsed time, or progression period, is calculated by subtracting the current date and time provided by timer 134 from the starting date and time 1212. Storage system 106 can then compare the calculated progression period against retention period 1214.

If the retention period has expired, storage system 106, in steps 706 and 708, resets the lock flag and retention period of the extent in the metatable. Otherwise, storage system 106 may simply delete the entire entry in the metatable. In step 710, storage system 106 resets the area of the extent in the locked blocks bitmap. Storage system 106 determines in step 712 whether shredding has been selected by checking the shredding flag in the metatable for the extent. If shredding has not been specified, storage system 106 begins the entire process for the next extent entry in the metatable. Otherwise, in step 714, storage system 106 executes extent shredding to the extent. Examples of extent shredding include overwriting the extent area with (i) random bit(s) or (ii) a character, its complement, and then a random character. This overwriting may include writing to the same address a number of times (e.g., one to seven times, or more) to ensure complete hardware decommissioning of data. After the execution of extent shredding, file server system 104 will not be able to read or recover the file(s) and the memory (physical or logical) becomes free space. Detailed procedures to ensure data decommission can be governed by the user's policy or regulatory requirements. In step 716, storage system 106 resets the shredding flag of the extent in the metatable or, alternatively, deletes the entire entry from the metatable.

FIG. 12 shows an exemplary format of a metatable 1200 generated by a system according to one embodiment of the present invention. The metatable includes an extent identifier 1202, extent address information (e.g., start block 1204, block size 1206, and/or end block (not shown)), retention flags (e.g., lock 1208 and shred flag 1210), retention information (e.g., start date of retention period 1212, duration of retention period 1214, and/or end date of retention period (not shown)). The metatable can also include information relating to each file stored within an extent. File information can include a file identifier 1216, file address information (e.g., start block 1218, block size 1220, and/or end block (not shown)), type of file 1222, and file owner 1224. Type of file 1222 should adequately describe the application program in order to reproduce the data. Based on the disclosure and teachings provided herein, a person of ordinary skill in the art will know how to select the appropriate data fields for the metatable, and include the appropriate number of data fields for identifiers, retention flags, retention information, and file information for a specific application.

The storage system can use the information provided by the metatable to determine whether a file is write protected and if shredding is required at the end of any retention period. In an embodiment of the invention, the metatable can only be directly accessed by storage system 106, and not by a user or application system 102, to safeguard the trustworthiness of the metatable. In another embodiment, metatable information, such as identifier 1202, start block 1204, file size 1206, file type 1222, and file owner 1224, can be used by a file reproducing system to reproduce the file if file server system 104 is not available.

As an another embodiment, a user on application system 102 can directly request file shredding. File server system 104 can receive a request and obtain the physical or logical address of the file (the address may be a list of blocks). Then, file server system 104 can call a block shredding function to be executed by storage system 106. Storage system 106 shreds the blocks corresponding to the file. Similar to extent shredding, block shredding may include overwriting the block area with (i) random bit(s) or (ii) a character, its complement, and then a random character. This overwriting may include writing to the same block area a number of times (e.g., one to seven times, or more) to ensure complete hardware decommissioning of data. Detailed procedures to ensure data decommission can be governed by the user's policy or regulatory requirements.

In yet another embodiment of the present invention, write protection and shredding can operate on individual blocks, instead of extents. This implementation may require metadata for each protected block, which would increase the complexity of control. In addition, memory needed to store the aggregate metadata would substantially increase.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the present invention has been described using a particular series of operations and steps, it should be apparent to those skilled in the art that the scope of the present invention is not limited to the described series of operations and steps.

Further, while the present invention has been described using a particular combination of hardware and software in the form of control logic and programming code and instructions, it should be recognized that other combinations of hardware and software are also within the scope of the present invention. The present invention may be implemented only in hardware, or only in software, or using combinations thereof.

It is understood that the examples and embodiments described herein are for illustrative purposes only and that various modifications or changes in light thereof will be suggested to persons skilled in the art and are to be included within the spirit and purview of this application and scope of the appended claims.

1. A storage system, comprising:
a storage area defined by a plurality of disks, the storage area defining at least one logical volume, the logical volume including a first portion of contiguous blocks and a second portion of contiguous blocks;
a storage controller to control access to the storage area by a file server system; and
a communication interface to couple the storage system to the file server system,
wherein first and second files are stored in the first and second portions, respectively, and
wherein the storage system is configured to lock the first portion without locking the second portion, so that first data of the first file stored in the first portion is protected according to an attribute associated with the first portion while the second data of the second file is not protected.

2. The storage system of claim 1, wherein the file server system and storage system are provided within the same housing.

3. The storage system of claim 1, wherein the file server system is remotely located from the storage system.

4. The storage system of claim 1, wherein the first and second portions of the logical volume are first and second extents, respectively.

5. The storage system of claim 1, wherein the storage system is further configured to store a retention period associated with the first portion.

6. The storage system of claim 5, wherein the storage system is further configured to overwrite the first portion with at least one random character at an expiration of the retention period.

7. The storage system of claim 1, wherein the storage system is a disk array unit.

8. A data retention system, comprising:
a file server system; and
a storage unit including a storage area defined by a plurality of disks, a storage controller to control access to the storage area by the file server system, and a communication interface to couple the file server system and the storage unit, the storage area defining at least one logical volume, the logical volume including a first portion of contiguous blocks and a second portion of contiguous blocks,
wherein first and second files are stored in the first and second portions, respectively, and
wherein the storage unit is configured to lock the first portion without locking the second portion, so that first data of the first file stored in the first portion is protected according to an attribute associated with the first portion while the second data of the second file is not protected.

9. The data retention system of claim 8, wherein the file server system and storage unit are provided within the same housing.

10. The data retention system of claim 8, wherein the file server system is remotely located from the storage unit.

11. The data retention system of claim 8, wherein the first and second portions of the logical volume are first and second extents, respectively.

12. The data retention system of claim 8, wherein the storage unit is further configured to store a retention period associated with the first portion.

13. The data retention system of claim 12, wherein the storage unit is further configured to overwrite the first portion with at least one random character at an expiration of the retention period.

14-28. (canceled)

29. A storage system, comprising:
a storage area defined by a plurality of disks, the storage area defining at least one logical volume, the logical volume including a first extent of contiguous blocks and a second extent of contiguous blocks;
a storage controller to control access to the storage area by a file server system; and
a communication interface to couple the storage system to the file server system,
wherein first and second files are stored in the first extent,
wherein a third file is stored in the second extent,
wherein the storage system is configured to lock the first extent without locking the second extent, so that first data of the first and second files stored in the first extent is protected according to an attribute associated with the first extent while the second data of the third file is not protected, and
wherein the first extent is overwritten with at least one random character at an expiration of a retention period.

30-34. (canceled)
